(19) United States
(12) Patent Application Publication
(10) Pub. No.: US 2026/0326301 A1
(43) Pub. Date: Oct. 22, 2026

(54) METHOD AND APPARATUS FOR CALIBRATING A ROBOT, METHOD FOR DETERMINING THE 3D COORDINATES OF A MEASUREMENT OBJECT, METHOD FOR DETERMINING THE POSITION AND ORIENTATION OF A MEASUREMENT OBJECT, AND COMPUTER PROGRAM

(71) Applicant: Carl Zeiss GOM Metrology GmbH, Braunschweig (DE)

(72) Inventors: Manuel Winter, Frankfurt (DE); Bennet Boettinger, Braunschweig (DE)

(21) Appl. No.: 19/714,373

(22) Filed: Jun. 19, 2026

Related U.S. Application Data
(63) Continuation of application No. PCT/EP2024/087043, filed on Dec. 18, 2024.

(30) Foreign Application Priority Data
Dec. 22, 2023 (DE) 10 2023 136 449.9

(51) Int. Cl. B25J 9/16

(52) U.S. Cl. CPC B25J 9/1692; B25J 9/1653; B25J 9/1669; B25J 9/1697

(57) ABSTRACT

A method for calibrating at least one robot kinematic system, including fastening a reference object with recognizable features to a first robot kinematic system, a 3D digitizer, and/or a camera to a second or a third robot kinematic system, bringing the reference object, the 3D digitizer, and/or the camera into different relative poses with respect to one another, recording data of the recognizable features by the 3D digitizer and/or the camera, and deriving calibration parameters for at least one of the robot kinematic systems. In addition, an apparatus for calibrating a plurality of robot kinematic systems with or as part of a coordinate measuring machine, a method for determining 3D coordinates of a measurement object, a method for determining the position and orientation of a measurement object, and a computer program which when executed causes a processor to carry out the methods are provided.

### CROSS REFERENCE TO RELATED APPLICATIONS

This application is a continuation application of international patent application PCT/EP2024/087043, filed Dec. 18, 2024, designating the United States and claiming priority to German application 10 2023 136 449.9, filed Dec. 22, 2023, and the entire content of both applications is incorporated herein by reference.

### TECHNICAL FIELD

The present disclosure relates to one or more robots, to a method and to an apparatus for calibrating one or more robots with a coordinate measuring machine or as part of a coordinate measuring machine, and to a method for determining the 3D coordinates of a measurement object and to a method for determining the position and orientation of a measurement object.

The present disclosure furthermore relates to a non-transitory computer-readable storage medium on which a computer program containing instructions that, when the program is executed by at least one processor, cause the at least one processor and/or further processors to carry out the methods according to the disclosure is stored.

### BACKGROUND

Robot kinematic systems (also referred to hereinafter as robots) are mechanical structures in which one or more axes are coupled to one another. Robot kinematic systems aim to bring an end effector into a specific position and orientation (pose) in relation to a reference system. An axis is understood here to mean the movable connection of two structural components of the robot kinematic system, wherein this connection may be movable in up to six degrees of freedom. Examples of this are a typical robot axis of rotation, which permits only a rotation in one rotational degree of freedom, a typical linear axis, which permits a translational movement in one translational degree of freedom, or a spherical joint (ball joint), which permits rotations in three rotational degrees of freedom. Typical robot kinematic systems are six-axis robots. In particular, however, a rotary table may also be considered to be a robot kinematic system. The robot axes here may either be provided with an actuator, or may be operated only passively. The reference system may for example be defined by the ground. Within the scope of the present disclosure, therefore, mobile robot kinematic systems traveling on corresponding mobile platforms may for example also be calibrated individually or with respect to one another. In this case, the reference system may be defined by the base of the platform, which does not move during the measurement.

Robot kinematic systems, whether parallel, serial or else parallel-and-serial coupled, such as for example an articulated arm on a delta robot, are inaccurate in many respects for measurement purposes. This means that the nominal forward kinematics do not correspond to the real forward kinematics. This is caused for example by geometric inaccuracies, elastic deformations, thermal expansions and inaccuracies in the determination of the axis values. This is especially problematic when the pose of the end effector or of the tool mounted on the end effector (measuring machine, work tool, etc.) must be determined with very high accuracy or is used for measurement purposes. The end effector is the end interface along the link chain of the robot kinematic system or the tool attached to the end interface.

In optical metrology, in particular 3D coordinate metrology, a measurement object can usually only be captured partially by an optical measurement system due to the latter's limited measurement range. The measurement system is therefore brought into different poses in relation to the measurement object with a robot in order to capture the measurement object as completely as possible. The data present locally in the reference coordinate system of the measurement system are then combined in a global coordinate system. It is necessary here to know the position and orientation of the measurement system in relation to the measurement object as accurately as possible. This accuracy is related directly to the positioning accuracy of the robot or to the accuracy with regard to the determination of the position of the end effector. Higher robot calibration accuracy enables more accurate determination of the position of the measurement system and, consequently, more accurate measurement of the measurement object as a whole.

Measurement objects may be so large that even the range of a robot is not sufficient to capture the measurement object with the measurement system attached to the robot. In this case, the measurement object must be displaced and realigned with respect to the robot in order, in this case too, to be able to transfer the data into a common global coordinate system before and after the displacement of the measurement object. This is usually carried out on the basis of recognizable features that are attached to or around the measurement object and are captured by the measurement system before and after the displacement. The better the robot is calibrated, the more accurate the alignment.

In 3D coordinate metrology, 3D digitizers are used to measure 3D data. The 3D data may be generated with different methods, such as for example by triangulation with at least two cameras or one camera and a projector, time-of-flight (TOF) measurement, lidar, confocal measurement, etc. In this case, the 3D data may be present for example in the form of individual 3D points of discrete features or as a full-field mesh consisting of a plurality of surface points. 3D data may also be generated with a 2D camera. However, a single 2D camera, which cannot generate 3D data in a single pose without further prior knowledge of the measurement object, such as for example a distance between features of the measurement object, is not a 3D digitizer in the context of the disclosure. 2D cameras are also referred to simply as cameras below.

EP 2 489 977 B1 describes a method involving a measurement system for determining the 3D coordinates of an object, including a camera and a projector and a reference camera for recording reference marks of an array of reference marks in order to determine the position and orientation of the measurement system from one or more recordings from the reference camera and an industrial robot for positioning the measuring system, wherein the measuring system and the array of reference marks are used to calibrate the robot.

Since the determination of the pose is inaccurate due to the acquisition of the data as 2D data with a reference camera and thus a 2D camera, particularly in the viewing direction of the 2D camera, EP 2 489 977 B1 furthermore proposes using multiple reference cameras aligned in different viewing directions. However, the use of further 2D cameras increases the costs of the system along with the weight that must be attached to the end effector of a robot. This may mean that it is necessary to use a robot that provides a correspondingly high load capacity.

EP 3 377 948 B1 describes a method in which, at a plurality of times of a sampling schedule, the poses of a camera system of a robot relative to a reference coordinate frame are obtained on the basis of a comparison of three-dimensional images of a scene and the positions of the robot are obtained on the basis of a second sampling schedule, in order to determine the position of the reference coordinate frame and the reference point of the camera system relative to the position of the robot. In this case, a plurality of equations are created and used to solve an optimization problem, with it being described that the position of the reference coordinate frame, the tool center point of the camera system, a possible time offset and parameters of the robot model can be optimized in the optimization method. One input parameter of the optimization method is the position of the camera system, which is given by a comparison of the three-dimensional images of the scene.

As mentioned in EP 3 377 948 B1, it is difficult, in particular in regions with few features, to align the three-dimensional images appropriately with visual odometry.

This is applicable in particular for low-resolution 3D digitizers with a small measurement volume. The larger the measurement volume, the higher the probability of capturing a feature, and the higher the resolution, the higher the probability of recognizing a feature or accurately capturing its position.

“Dynamic Photogrammetric Calibration of Industrial Robots” Videometrics V, SPIE Proceedings Series Vol. 3174, SPIE's 42nd Annual Meeting, San Diego, 27.7.-1.8. 1997 describes a method for calibrating a robot, in which a reference object is attached to a robot and 3D coordinates of marked targets of the reference object are determined by being recorded with three mutually synchronized cameras. The poses of the end effector are determined on the basis of the 3D coordinates of the marked targets. The 3D coordinates and the orientation and the camera model parameters of the three-camera system are determined simultaneously in this case.

The drawback of the method is that inexpensive cameras have a very low resolution, and it is thus not possible to determine, very accurately, the position of the points of the reference object in the camera images, and thus also in space.

### SUMMARY

It is an object of the present disclosure to provide a method and an apparatus for calibrating a robot kinematic system and also a method for determining the 3D coordinates of a measurement object and a method for determining the position and orientation of a measurement object and also a robot kinematic system and a non-transitory computer-readable storage medium on which a computer program for carrying out the method according to an aspect of the disclosure is stored, thereby solving the abovementioned problems.

Against this background, what is proposed according to an aspect of the disclosure is a method for calibrating robot kinematic systems, which includes at least one reference object having recognizable features which is fastened to a first robot kinematic system, and at least one 3D digitizer, wherein the 3D digitizer is fastened to a further second robot kinematic system or to a further third robot kinematic system, and/or at least one camera, wherein the camera is fastened to the second robot kinematic system or to the third robot kinematic system, wherein the reference object and the 3D digitizer and/or the camera are brought into different relative poses with respect to one another by the first robot kinematic system and the second robot kinematic system and/or the third robot kinematic system, and in which data of the recognizable features of the reference object are recorded by the at least one 3D digitizer and/or the at least one camera in these different relative poses, and calibration parameters for at least one of the robot kinematic systems are derived at least from a portion of the recorded data.

The respective robot kinematic systems may expediently be moved via a controller that controls all robot kinematic systems. The advantage of the present method is that at least two robot kinematic systems can thereby be calibrated in a calibration method, and not every robot kinematic system has to be calibrated individually, and multiple robot kinematic systems then must be calibrated successively. Furthermore, as a result of the method according to an aspect of the disclosure, the position and orientation of the two robot kinematic systems with respect to one another is also known. The calibration may be carried out without additional aids. It is sufficient for the reference object to be fastened to a first robot kinematic system and a 3D digitizer or a camera to be fastened to a second or third robot kinematic system. There is therefore no need for hand-eye calibration for the second or third robot kinematic system to which the 3D digitizer or the camera is fastened, since this is already included in the method according to an aspect of the disclosure. If the reference object is replaced by a tool, the hand-eye calibration may be carried out by the 3D digitizer already fastened to the second or third robot kinematic system or by the camera already fastened to the second or third robot kinematic system.

It goes without saying that the camera may also be part of the 3D digitizer. Of course, this also applies to the following method claims for calibrating a measurement object and aligning a measurement object, and to the corresponding apparatus claims.

According to a further aspect of the present disclosure, what is proposed is a method for determining the 3D data of a measurement object, wherein at least one 3D digitizer fastened to a robot kinematic system or multiple 3D digitizers fastened to robot kinematic systems are brought into different poses for measuring the measurement object, and the one or more 3D digitizers generate local 3D data in the reference coordinate systems of the 3D digitizers, and wherein the local 3D data generated at the different poses are transferred into a global coordinate system on the basis of the calibration parameters of the robot kinematic systems as derived in accordance with the method according to an aspect of the disclosure.

According to a further aspect of the present disclosure, what is proposed is a method for aligning a measurement object in relation to a robot kinematic system on the basis of recognizable features that are distributed on or around the measurement object and are captured by at least one 3D digitizer fastened to a robot kinematic system and/or by at least one camera fastened to a robot kinematic system, wherein the calibration parameters of the robot kinematic system have been derived with the method according to an aspect of the disclosure.

According to a further aspect of the present disclosure, what is proposed is an apparatus for calibrating robot kinematic systems, said apparatus including at least the following components: at least one reference object fastened to a first robot kinematic system and which has recognizable features, and at least one 3D digitizer, wherein the 3D digitizer is fastened to a further second robot kinematic system or to a further third robot kinematic system, and/or at least one camera, wherein the camera is fastened to the second robot kinematic system or to the third robot kinematic system, wherein calibration parameters for at least one of the robot kinematic systems are derived in accordance with the method according to an aspect of the disclosure.

According to a further aspect of the present disclosure, what is proposed is a robot kinematic system the calibration parameters of which have been derived with the method according to an aspect of the disclosure.

What is furthermore proposed is a computer program containing instructions that, when the program is executed by at least one processor, cause this at least one processor and/or further processors to carry out the method according to an aspect of the disclosure.

According to another aspect of the disclosure, a method for calibrating robot kinematic systems is provided. With this method, it is possible to calibrate one, but in particular also two or three, of the robot kinematic systems in a method sequence according to an aspect of the disclosure. Calibrating two or more robot kinematic systems makes it possible to determine the position and orientation of the end effectors of the respective robot kinematic system with respect to one another. However, this also means for example that, if a reference object is replaced by a measurement object on the first robot kinematic system, the position and orientation between the measurement object and the 3D digitizer is known on the basis of the derived calibration parameters, and the recorded 3D data present in the local reference coordinate system of the 3D digitizer can thus be transferred to the correct location in the reference coordinate system of the measurement object, so as to give a correctly contiguous overall image of the measurement object from the data of the individual recordings of the respective poses of the measurement object and of the 3D digitizer, wherein the overall image also consists of or includes 3D data. In order to move from one pose to the next, the robot kinematic systems may move successively, but also simultaneously. Furthermore, for example, the 3D digitizer may additionally also be replaced by a tool, such that processing of an object attached to the first robot kinematic system by the tool attached to the second robot kinematic system is carried out precisely on the basis of the derived calibration parameters of the robot kinematic systems. It should be pointed out at this juncture that there are still many further examples of how two or more robot kinematic systems that have been calibrated in accordance with the method according to an aspect of the disclosure may advantageously be combined with one another.

The data for the derivation of the calibration parameters are recorded by virtue of a reference object having recognizable features which is fastened to a first robot kinematic system, and at least one 3D digitizer, wherein the 3D digitizer is fastened to a second robot kinematic system or to a third robot kinematic system, and/or at least one camera, wherein the camera is fastened to a second robot kinematic system or to a third robot kinematic system, being brought into different relative poses with respect to one another and data of the recognizable features of the reference object being recorded in these different relative poses. It is thus possible, that the 3D digitizer and the camera are fastened to a second robot kinematic system or that the 3D digitizer is fastened to a second robot kinematic system and the camera is fastened to a third robot kinematic system or that the camera is fastened to a second robot kinematic system and the 3D digitizer is fastened to a third robot kinematic system. It is also possible that only a 3D digitizer or only a camera is/are fastened to the second robot kinematic system.

Furthermore, the abovementioned robot kinematic systems may be supplemented with any other desired robot kinematic systems in order to calibrate them in accordance with the method according to an aspect of the disclosure. For example, a robot kinematic system may be supplemented with a reference object and three further ones each with a 3D digitizer, etc.

On the one hand, the recorded data may be 2D data that are recorded with one or more cameras, these possibly also being one or more cameras of the 3D digitizer. On the other hand, it may be 3D data generated by the 3D digitizer.

The newly determined calibration parameters may then be used to determine the pose of a 3D digitizer more accurately and thus measure a measurement object more accurately.

Furthermore, the newly determined calibration parameters also enable more accurate alignment of a measurement object with respect to the calibrated robot kinematic system.

The abovementioned object is thus achieved in its entirety.

According to a further exemplary embodiment, the 3D digitizer is a triangulation sensor, in particular one with structured light projection.

The advantage of triangulation sensors is that they can determine 3D data very accurately and may also be realized relatively easily, for example by combining two cameras or one camera and a projector.

According to a further exemplary embodiment, the reference object is calibrated or recalibrated within the method according to an aspect of the disclosure, and the recognizable features of the reference object are thus correlated in a coordinate system, or the reference object is calibrated beforehand or afterwards, outside the method according to an aspect of the disclosure.

In order to calibrate a robot kinematic system on the basis of a reference object, the reference object must be calibrated with high accuracy. This may be achieved for example by virtue of the reference object having been calibrated beforehand in a calibration laboratory, that is to say outside the method according to an aspect of the disclosure. If the reference object does not remain calibrated stably over the long term, regular calibration is necessary in order to ensure lasting accuracy. This may be implemented, within the method according to an aspect of the disclosure, such that the reference object is calibrated with high accuracy during the method according to an aspect of the disclosure through the generation of calibration data that correlate the recorded features of the reference object in a coordinate system, and the complexity of preliminary calibration and long-term stability is thus dispensed with.

Since the requirement for long-term stability of the reference object is reduced in this case, it is possible to use a lightweight reference object fastened to a robot kinematic system, as a result of which the load capacity on the robot kinematic system can be reduced.

Influencing variables, such as for example gravitational alignment of the reference object or ambient temperature, may also be taken into account here. It is thus accordingly possible for example to carry out the generation of calibration data at different ambient temperatures and to generate the calibration data or the references of the recorded recognizable features of the at least one reference object in a temperature-dependent manner in a coordinate system, with it being necessary to take into account that enough recordings of the recognizable features of the at least one reference object are generated at the different ambient temperatures. On account of the existing temperature dependence of the references of the recorded recognizable features of the at least one reference object, this may lead to improved ambient temperature-dependent calibration of the robot kinematic system.

The generation of calibration data and the derivation of calibration parameters may take place simultaneously in one step, that is to say for example in an optimization process. However, it may also take place in multiple steps, such that for example the calibration data are generated first and the calibration parameters are then determined separately in another step on the basis of the previously generated calibration data.

According to a further exemplary embodiment, the data for generating the calibration data and for deriving the calibration parameters may be different, identical or partially identical.

The utilization of a camera, especially if it is a high-resolution camera, is advantageous for calibrating the recognizable features of the reference object. The utilization of a 3D digitizer is advantageous for determining the pose of the end effector, since depth data are also relevant in particular for the pose. Nevertheless, it is also possible to utilize a camera to determine the pose of the end effector or a 3D digitizer to calibrate the recognizable features of the reference object or to combine both with one another.

Thus, for example, to generate calibration data, it may be helpful to use only data that have been recorded with a high-resolution camera and, to derive the calibration parameters, to use only data that have been recorded with the 3D digitizer, meaning that they are completely different. However, it may also be helpful for example to select poses such that the recorded data are suitable both for generating calibration data and for deriving calibration parameters, and the datasets are thus suitable for generating calibration data and for deriving calibration parameters, and they may thus be completely or at least partially identical. This advantageously makes it possible to reduce the time needed to record the data.

According to a further exemplary embodiment, a scale-defining element is present on the reference object and/or a robot link itself is a scale-defining element.

A scale-defining element is advantageous in order to be able to define the distances between the recognizable features in absolute terms, and not just in relative terms. In particular, if only 2D data are present, the distances between the recognizable features of the reference object are scalable if there is no fixed reference to a scale-defining element. The scale-defining element is for example a stable precision body. It is calibrated with high accuracy, usually with a tactile coordinate measuring machine, and consists of a material that hardly expands, ideally does not expand at all, in the event of a temperature change. The precision bodies are usually simple shapes of a scale bar, such as for example a ball bar. The advantage is that, by generating the calibration data, the accuracy of the precision body is transferred to the reference object, which has a relatively complex structure, without the reference object itself having to be calibrated with high accuracy (for example in tactile fashion). However, a scale-defining element may also be an exactly measured distance between two recognizable features of the reference object.

According to a further exemplary embodiment, the recognizable features of the reference object are correlated in absolute terms by at least one absolute measurement with the 3D digitizer, wherein the 3D digitizer itself is thus the scale-defining element.

A calibrated 3D digitizer measures 3D data in absolute terms. A measurement of the recognizable features of the reference object using the 3D digitizer may accordingly be used to determine the distances between the recognizable features of the reference object, which may be present only in relative terms, in absolute terms. This advantageously makes it possible to dispense with a scale-defining element on the reference object.

According to a further exemplary embodiment, at least a portion of the local data of the recognizable features of the reference object that are present in the local reference coordinate system of the 3D digitizer and/or that are present in the local reference coordinate system of the camera are transferred into a global reference coordinate system.

To transfer or transform the local data of the recognizable features of the reference object (actual observations) into a global coordinate system, it is helpful to know the pose of the 3D digitizer attached to the end effector and/or of the camera attached to the end effector or of the reference object attached to the end effector. This results from the forward kinematics of the robot kinematic system and the relationship between the 3D digitizer and/or camera or reference object and the end effector. The forward kinematics, or else forward transformation, is the function that describes the position and orientation of the end effector, and also individual robot links in a given coordinate system, as a function of the robot configuration, which is given in the axis space (that is to say for example angular positions of rotary joints or linear positions of linear axes). To do this, the coordinate transformations for example of the individual robot links must be known. Nominally, these coordinate transformations for a given robot are known for example from data sheets, technical drawings, CAD data, given Denavit-Hartenberg parameters, or the like. The local data present in the local reference coordinate system of the 3D digitizer or of the camera relate for example to the position and orientation of the camera sensors. In the case of a triangulation sensor, this is predefined for example by the calibration of the triangulation sensor. The lengths and angles necessary for the transformation between the local reference coordinate system of the camera sensor and the coordinate system of the end effector may therefore be read nominally for example from the CAD data of the 3D digitizer and/or of the camera and any necessary adapters between the 3D digitizer and the end effector. Likewise, for example, CAD data of the reference object may also be used to establish a relationship between the end effector and the recognizable features of a reference object fastened to the end effector.

The calculation of the forward kinematics from these nominally known values (that is to say values not aligned with reality by any kind of calibration) is referred to hereinafter as “nominal forward kinematics”. However, due to, for example, geometric inaccuracies, elastic or thermal deformations or inaccuracies in the determination of the axis angles or lengths of the robot links, the accuracy of the position determination of the 3D digitizer and/or of the camera or of the reference object on the robot kinematic system is usually not sufficient. The nominal forward kinematics thus differ from the real ones.

The data present in the global coordinate system after the transformation are then used as starting values for subsequent optimization methods. The transformation into a global coordinate system with the forward kinematics makes it more likely to find a better extremum of the optimization methods.

According to a further exemplary embodiment, the calibration parameters of the at least one robot kinematic system are derived and, optionally, before the derivation of the calibration parameters or during the derivation of the calibration parameters, the reference object is calibrated and, optionally, the calibration parameters of the at least one 3D digitizer or of the at least one camera are adapted, in such a way that the deviations between the coordinates of the recorded recognizable features of the reference object and the coordinates of the recognizable features of the reference object as calculated from a mathematical model are minimized.

In this case, a deviation may be for example a deviation of the position and/or a deviation of the orientation of the recognizable features of the reference object.

The reference object is calibrated by virtue of calibration data, which correlate the recorded features of the reference object in a coordinate system, being generated at least from a portion of the recorded data.

If the reference object has not been calibrated or is intended to be recalibrated, this may be done with an optimization method for generating the calibration data with the data, provided for this purpose, for generating the calibration data, for example in accordance with a mathematical model by way of bundle adjustment in accordance with Luhmann Robson, Kyle, Boehm, Close Range Photogrammetry and 3D Imaging, Second Edition, chapter 4, ISBN 978-3-1110-2986-3. The calibration parameters may be derived in a further optimization method by minimizing the deviations between the recorded recognizable features of the reference object and the recognizable features of the reference object as correlated from the calibration data. This may be done for example in accordance with a mathematical model containing the calibration parameters of the robot kinematic system, using methods for solving a nonlinear optimization problem according to Nocedal, Wright, Numerical Optimization, Second Edition, ISBN 978-1-4939-3711-0. However, both optimization methods may likewise be combined to form one optimization method. If necessary, the calibration parameters of the 3D digitizer and/or of the camera may also be adapted within a separate or combined optimization method if a scale-defining element is captured by the 3D digitizer and/or the camera (see Luhmann, Robson, Kyle, Boehm, Close Range Photogrammetry and 3D Imaging, Second Edition, ISBN 978-3-1110-2986-3) or, if necessary, the calibration parameters of the 3D digitizer and/or of the camera may also be adapted without a scale-defining element being captured by the 3D digitizer and/or the camera, if one of the robot links and thus a portion of the robot kinematic system itself is the scale-defining element. Likewise, if necessary, scale-independent calibration parameters of the 3D digitizer and/or of the camera may also be adapted without a scale-defining element being captured, if the scale-dependent parameters of the calibration of the 3D digitizer and/or of the camera have been captured beforehand with a scale-defining element.

The method according to an aspect of the disclosure may thus be used to calibrate a robot kinematic system, if necessary to calibrate the reference object and if necessary also to calibrate the 3D digitizer or the camera.

The minimization advantageously provides an ideal solution to the optimization problems.

While the optimization methods and the identification of the calibration parameters may be formulated with the aid of the forward kinematics, it is just as possible to establish an equivalent optimization problem with the aid of the inverse kinematics.

According to a further exemplary embodiment, the calibration parameters of the robot kinematic system are geometric and/or elastic and/or thermal calibration parameters and/or calibration parameters of the robot kinematic system that take into account the configuration of the robot kinematic system, and/or calibration parameters that take into account the direction of approach, and/or calibration parameters of the characteristic of the or calibration parameters for determining the error curves of the length or angle measurement technology of the robot kinematic system and/or calibration parameters that characterize the play of individual or all axes of the robot kinematic system and/or calibration parameters that describe the dependence of the robot kinematic system on other variables, which may for example be recorded using sensors or be calculated on the basis of the existing data.

Depending on the type of a robot kinematic system and depending on the ambient conditions of the robot kinematic system and depending on the type of 3D digitizer or camera and reference object, it is useful to use different combinations of calibration parameters for the optimization.

However, the method according to an aspect of the disclosure is not restricted to these calibration parameters, and may be supplemented and combined with other parameters.

According to a further exemplary embodiment, the calibration parameters are used to determine the pose of the end effector of the robot kinematic systems and/or to align the end effector on the basis of the parameters.

The adapted calibration parameters resulting from the optimization method may be used to place the end effector of the robot kinematic system more accurately. This is expedient if the measurement of a measurement object takes place after the robot kinematic system has been calibrated. However, the calibration parameters may also be used to accurately determine a pose of the end effector. It is thus possible, for example, to use an inexpensive robot kinematic system the approach accuracy of which into a certain pose is low for mechanical reasons, but the pose of which is nevertheless able to be determined accurately through the adapted calibration parameters. Furthermore, it is therefore also possible to subsequently correct the poses of a measurement.

If a 3D digitizer or a camera is attached to the robot kinematic system and these are also used as measurement sensors, the forward kinematics already contain the transformation from the global reference coordinate system to the local reference coordinate system of the 3D digitizer or camera. No additional hand-eye calibration is thus necessary. If the reference object attached to the first robot kinematic system is replaced by a tool, then a hand-eye calibration may be carried out between a local reference coordinate system of the tool and a reference coordinate system of the first robot kinematic system with the camera or the 3D digitizer fastened to the second or third robot kinematic system. There is thus no need for an additional system for carrying out the hand-eye calibration.

According to a further exemplary embodiment, 3D digitizers and/or cameras and/or reference objects are fastened to multiple robot kinematic systems, and at least one of the robot kinematic systems is calibrated in accordance with the method according to an aspect of the disclosure.

Thus, for example, a combination is possible in which the reference object is fastened to a robot kinematic system and respective 3D digitizers are fastened to two or more other robot kinematic systems. It is likewise conceivable for respective reference objects to be fastened to two or more robot kinematic systems, and for the 3D digitizer and/or the camera to be fastened to a robot kinematic system.

A constellation of multiple robot kinematic systems is likewise possible, in which one, multiple or all robot kinematic systems are provided both with a 3D digitizer and/or a camera and with a reference object. The reference object may be attached to the robot kinematic system at any desired location.

In principle, it is possible to realize various combinations of robot kinematic systems with 3D digitizers, cameras and reference objects in accordance with the method according to an aspect of the disclosure.

According to a further exemplary embodiment, at least one of the robot kinematic systems is a rotary table.

A rotary table is particularly advantageous if 3D data are to be determined not only on the front face of a measurement object, but also on the sides and/or on the back face and a further robot kinematic system to which the 3D digitizer is fastened cannot reach the sides or the back face of the measurement object, this however being made possible by the rotary table.

The rotary table may be calibrated individually or with a further robot kinematic system, for example a six-axis robot.

According to a further exemplary embodiment, the robot kinematic systems are calibrated relative to one another.

If for example two or more 3D digitizers each fastened to a robot kinematic system measure the reference object, then this has the advantage for example that all coordinate systems of the end effectors of the respective robot kinematic systems can be transferred into a common global reference coordinate system. This also works for the combination with two or more reference objects, each of which is attached to a robot kinematic system.

This means, for example in relation to the measurement of a measurement object, that it is possible to use two or more robot kinematic systems with 3D digitizers fastened to each thereof and it is possible to represent the data of the respective 3D digitizers in a common global reference coordinate system.

It is also possible to calibrate entire series of robot kinematic systems and to transfer them into a common reference coordinate system.

According to a further exemplary embodiment, in addition to a 3D digitizer and/or camera and/or reference object, one or more further tools are fastened to the robot kinematic system and/or the 3D digitizer and/or the camera and/or the reference object on the robot kinematic system are replaced by one or more tools.

It is thereby possible for the method according to an aspect of the disclosure to be used not only for 3D coordinate metrology, but also for further robot kinematic tasks.

According to a further exemplary embodiment, the reference object is configured such that the recognizable features are located on a separate body and/or on one or more arbitrary links of a robot kinematic system and/or on a 3D digitizer or a camera and/or on a tool and/or on a measurement object and/or around a measurement object.

Depending on the application, configuration, and ambient conditions of a robot kinematic system, it is advantageous to create a reference object with a specific arrangement of the recognizable features for the method according to an aspect of the disclosure.

In this case, the reference object may be a separate body fastened to the end effector. The reference object may be attached to any robot link and also extend over one or more links of the robot kinematic system. It may be located on the end effector of the robot kinematic system or on a tool fastened to the end effector. The reference object may consist of multiple partial reference objects. The partial reference objects may be constructed so as to be spatially separate from one another. The reference object may also be part of the 3D digitizer. It is thereby possible for example for two robot kinematic systems to be mutually calibrated if each robot kinematic system carries a 3D digitizer to which recognizable features are attached, and the respective derived calibration parameters are checked against one another or linked to one another. The reference object is normally an object separate from the measurement object. However, a combination of both objects is likewise possible.

According to a further exemplary embodiment, the recognizable features are optical markers that actively light up and/or are passively illuminated, and/or features recognizable in two dimensions having a unique 2D geometry and/or features recognizable in three dimensions having a unique 3D geometry.

Depending on the type and application of a 3D digitizer or camera, it is advantageous to use corresponding recognizable features.

Features recognizable in two dimensions may be for example patterns, circles, holes, spheres, edges or corners; features recognizable in three dimensions may be for example spheres, cylinders, cones, etc.

According to a further exemplary embodiment, the camera is removed from the robot kinematic system when it is not being used.

This has the advantage of improving the accessibility of the 3D digitizer to the reference object and to a measurement object. Thus, for example, if the measurement object is an automobile chassis, it is much easier also to carry out a measurement in the automobile chassis if the camera has been removed from the robot kinematic system, to which the 3D digitizer is also fastened, for the measurement process.

It goes without saying that the abovementioned features and the features still to be explained below may be used not only in the respectively indicated combination but also on their own or in other combinations, without departing from the scope of the present disclosure.

Moreover, it goes without saying that the features defined in the dependent claims for the method for calibrating the robot kinematic systems may also be used in the same way or equivalently as apparatus features for the method according to the disclosure, without being listed again separately here as apparatus features.

The indefinite term “a”/“an” is to be understood within the meaning of the present disclosure not as a numeral, but as an indefinite term in the sense of “at least one”. Consequently, the features specified by “an element” also include within their meaning multiple such elements, such as for example multiple robot kinematic systems or a robot kinematic system with one or more 3D digitizers, cameras or reference objects. In addition, further, other elements are not ruled out.

### BRIEF DESCRIPTION OF THE DRAWINGS

The disclosure will now be described with reference to the drawings wherein:

FIG. 1 shows a schematic illustration of an apparatus for calibrating robot kinematic systems, with two robot kinematic systems, according to an exemplary embodiment of the disclosure;

FIG. 2 shows a schematic illustration of an apparatus for measuring a measurement object according to an exemplary embodiment of the disclosure;

FIG. 3 shows a further schematic illustration of an apparatus for measuring a measurement object according to an exemplary embodiment of the disclosure; and

FIG. 4 shows a further schematic illustration of an apparatus with a rotary table and a six-axis robot according to an exemplary embodiment of the disclosure.

### DESCRIPTION OF EXEMPLARY EMBODIMENTS

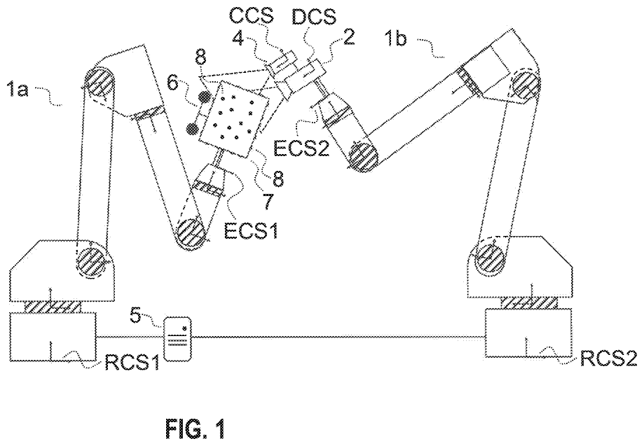

FIG. 1 shows an exemplary embodiment of one of multiple possible apparatuses according to an exemplary embodiment the disclosure. Said apparatus has a reference object 7, having recognizable features 8, which is fastened to a first robot kinematic system 1a, and a 3D digitizer 2, wherein the 3D digitizer 2 is fastened to a second robot kinematic system 1b, and a camera 4, wherein the camera 4 is also fastened to the second robot kinematic system 1b. The robot kinematic system 1a and the robot kinematic system 1b bring the reference object 7 and the 3D digitizer 2 together with camera 4 into different relative poses with respect to one another. Data of the recognizable features 8 of the reference object 7 are recorded by the 3D digitizer 2 and/or by the camera 4 in these different relative poses, and calibration parameters for at least one of the robot kinematic systems 1a, 1b are derived from at least a portion of the recorded data. In this exemplary embodiment, the robot kinematic systems 1a, 1b are six-axis robots. The axes are each identified by hatching here. The apparatus, as well as the exemplary embodiments mentioned below, may be controlled here for example with a computer 5. Said computer contains a non-transitory computer-readable storage medium on which a computer program is stored. The computer program contains instructions that, when the program is executed by at least one processor or by further processors, cause the at least one processor and/or the further processors to carry out the method according to an aspect of the disclosure.

A further possible apparatus may be provided in that the reference object 7 is fastened to a first robot kinematic system 1a, the 3D digitizer 2 is fastened to a second robot kinematic system 1b and the camera 4 is fastened to a third robot kinematic system 1c (not illustrated).

In order to calibrate a robot kinematic system 1a, 1b, 1c on the basis of the reference object 7, the reference object 7 must be calibrated with high accuracy. This may be achieved for example by virtue of the reference object 7 having been calibrated beforehand in a calibration laboratory, that is to say outside the method according to an aspect of the disclosure. If the reference object 7 does not remain calibrated stably over the long term, regular calibration is necessary in order to ensure lasting accuracy. This may be implemented, within the method according to an aspect of the disclosure, such that the reference object 7 is calibrated with high accuracy during the method according to an aspect of the disclosure through the generation of calibration data that correlate the recorded features 8 of the reference object 7 in a coordinate system, and the complexity of preliminary calibration and long-term stability is thus dispensed with.

Calibration data may be generated with data consisting at least in part of or including at least in part the recorded data that have been recorded in the different relative poses during execution of the method according to an aspect of the disclosure.

The reference object 7 may be configured such that the recognizable features 8 are located on a separate body and/or on one or more arbitrary links of a robot kinematic system 1a, 1b, 1c and/or on a 3D digitizer 2 or a camera 4 and/or on a tool and/or on a measurement object 9 and/or around a measurement object 9.

The recognizable features 8 may be optical markers that actively light up and/or are passively illuminated, and/or features 8 recognizable in two dimensions having a unique 2D geometry and/or features 8 recognizable in three dimensions having a unique 3D geometry.

A scale-defining element 6 may optionally be applied to the reference object 7 in order to be able to define the distances between the recognizable features 8 in absolute terms, and not just in relative terms. The scale-defining element 6 is for example a stable precision body. It is calibrated with high accuracy, usually with a tactile coordinate measuring machine, and consists of a material that hardly expands, ideally does not expand at all, in the event of a temperature change. The precision bodies are usually simple shapes of length gages, such as for example a ball bar. The advantage is that, by generating the calibration data, the accuracy of the precision body is transferred to the reference object 7, which has a relatively complex structure, without the reference object 7 itself having to be calibrated with high accuracy (for example in tactile fashion).

A scale-defining element 6 may also be given by the, or one of the, 3D digitizer(s) 2, by virtue of the 3D digitizer 2 providing at least one recording of 3D data. An additional scale-defining element 6, as illustrated in FIG. 1, is thus not absolutely necessary. The 3D digitizer 2 may be the scale-defining element 6, since it uses at least one 3D data recording to measure the distances between the recognizable features 8 of the reference object 7 in absolute terms based on the calibration of the 3D digitizer 2. The recognizable features 8 of the reference object 7, which may be correlated from 2D data only relatively when the calibration data are generated, may accordingly be correlated in absolute terms by combination with at least one recording of 3D data of the 3D digitizer 2. It would likewise be conceivable for one of the robot links itself to be the scale-defining element. In this case, no further scale-defining element would be required for the method according to an aspect of the disclosure.

The data recorded for the purpose of generating the calibration data may originate from the 3D digitizer 2 and/or the camera 4.

Typically, a high-resolution digital camera is used to generate the calibration data, wherein said digital camera is brought into a large number of different relative poses with respect to the reference object 7 in order to record images of the recognizable features 8 of a reference object 7. From the images recorded in these poses, bundle adjustment (in accordance with Luhmann, Robson, Kyle, Boehm, Close Range Photogrammetry and 3D Imaging, Second Edition, chapter 4, ISBN 978-3-1110-2986-3) may be used to correlate the recognizable features 8 of a reference object 7 in a coordinate system.

Usually, the bundle adjustment uses 2D data. However, it is likewise conceivable to use 3D data of a 3D digitizer 2.

To derive the calibration parameters of the robot kinematic system 1a, 1b, 1c, it is possible, on the one hand, to use 2D data that are recorded for example using a camera 4. Advantageously, it is in particular also possible to use 3D data that are recorded by a 3D digitizer 2, in particular a triangulation sensor, since triangulation sensors can determine 3D data very accurately and can also be realized relatively easily, for example by the combination of two cameras or one camera and a projector.

By way of example, a stripe projection system may be used as triangulation sensor. This consists for example of two cameras and a projector for projecting fringe images. In this case, homologous image points, that is to say points that image the same object point of a surface in the two cameras, are triangulated, and the object point is thus determined in space, that is to say a 3D coordinate is generated in the local reference coordinate system DCS of the stripe projection system with respect to the object point. Since a stripe projection system records a plurality of homologous image points, it is an area sensor. It is thus also possible to generate 3D data of multiple recognizable features 8 of a reference object 7 at a pose of the stripe projection system. On account of the high accuracy of the 3D data of the stripe projection system in all three spatial dimensions, the pose of the stripe projection system in relation to the reference object 7 can be determined with very high accuracy, and the robot kinematic system 1a, 1b, 1c can thus be calibrated with very high accuracy. (See also Luhmann, Robson, Kyle, Boehm, Close Range Photogrammetry and 3D Imaging, Second Edition, chapter 6, ISBN 978-3-1110-2986-3).

In this case, it may be expedient, in order to record the recognizable features 8 of the reference object 7 with the 3D digitizer 2 and/or the camera 4, to approach those poses that are suitable for calibrating the robot kinematic system 1a, 1b, c. Use is made here for example of poses that cover as many axis angles as possible or poses that generate different gravitational effects on the robot links or axes of the robot kinematic system 1a, 1b, 1c, while it may be expedient, for generating calibration data, to approach poses in such a way that the recognizable features 8 of the reference object 7 are calibrated accurately.

However, it may also be the case that use is made of poses that are suitable both for generating calibration data and for deriving calibration parameters of the robot kinematic system 1a, 1b, 1c. The data recorded in this case may then be identical for the generation of the calibration data and for the derivation of the calibration parameters.

Generally speaking, the data for generating the calibration data and for deriving the calibration parameters may be different, identical or partially identical. Furthermore, the chronological order in which the data are recorded is also irrelevant.

A portion of the data of the recognizable features 8 of the reference object 7 present in the local reference coordinate system DCS of the 3D digitizer 2 or in the local reference coordinate system CCS of the camera 4 may be transformed into a global reference coordinate system, for example RCS1 or RCS2, wherein other reference coordinate systems, including non-global reference coordinate systems, are also conceivable. This concerns in particular the portion of the data used to derive the calibration parameters.

To transform the local data (actual observations) into a global coordinate system, for example RCS1 or RCS2, it is helpful to know the pose of the 3D digitizer 2 attached to the end effector and/or of the camera 4 attached to the end effector or of the reference object 7 attached to the end effector. This results from the forward kinematics of the robot kinematic system 1a, 1b, 1c and the relationship between the 3D digitizer 2 and/or camera 4 and/or reference object 7 and the end effector. The forward kinematics, or else forward transformation, is the function that describes the position and orientation of the end effector or its coordinate system ECS1, ECS2, and also individual robot links in a given coordinate system, for example RCS1 or RCS2, as a function of the robot configuration, which is given in the axis space (that is to say for example angular positions of rotary joints or linear positions of linear axes). To do this, the coordinate transformations of the individual robot links must be known. Nominally, these coordinate transformations for a given robot are known for example from data sheets, technical drawings, CAD data, given Denavit-Hartenberg parameters, or the like. The data present in the local reference coordinate system of the 3D digitizer 2 or of the camera 4 relate for example to the position and orientation of the camera sensors. In the case of a triangulation sensor, this is predefined by the calibration of the triangulation sensor. The lengths and angles necessary for the transformation between the local reference coordinate system (DCS, CCS) of the camera sensor and the coordinate system of the end effector (ECS1, ECS2) may therefore be read nominally for example from the CAD data of the 3D digitizer 2 and/or of the camera 4 and any necessary adapters between the 3D digitizer 2 and/or camera 4 and the end effector. Likewise, CAD data of the reference object 7 may also be used to establish a relationship between the end effector and the recognizable features 8 of a reference object 7 fastened to the end effector. The relationship between RCS1 and RCS2 may for example likewise be taken from CAD data or may have been measured.

With regard to carrying out coordinate transformations, reference is made to Luhmann, Robson, Kyle, Boehm, Close Range Photogrammetry and 3D Imaging, Second Edition, chapter 2, ISBN 978-3-1110-2986-3.

The calculation of the forward kinematics from these nominally known values (that is to say values not aligned with reality by any kind of calibration) is referred to hereinafter as “nominal forward kinematics”. However, due for example to geometric inaccuracies, elastic or thermal deformations or inaccuracies in the determination of the axis angles or lengths of the robot links, the accuracy of the position determination of the 3D digitizer 2 and/or of the camera 4 or of the reference object 7 on the robot kinematic system 1a, 1b, 1c is usually not sufficient. The nominal forward kinematics thus differ from the real ones.

The data present after the transformation in the global coordinate system, for example RCS1 or RCS2, are then used as starting values for a subsequent optimization method. The transformation into a global coordinate system RCS1 or RCS2 using the forward kinematics makes it more likely to find a better extremum of the optimization method.

In the optimization method, the calibration parameters of the at least one robot kinematic system 1a, 1b, lc may be derived and, optionally, before the derivation of the calibration parameters or during the derivation of the calibration parameters, the reference object 7 may be calibrated and, optionally, the calibration parameters of the at least one 3D digitizer 2 or of the at least one camera 4 may be adapted, in such a way that the deviations between the coordinates of the recorded recognizable features 8 of the reference object 7 and the coordinates of the recognizable features 8 of the reference object 7 as calculated from a mathematical model are minimized.

In this case, a deviation may be for example a deviation of the position and/or a deviation of the orientation of the recognizable features 8 of the reference object 7.

The reference object 7 is calibrated by virtue of calibration data, which correlate the recorded features 8 of the reference object 7 in a coordinate system, being generated at least from a portion of the recorded data.

If the reference object 7 has not been calibrated or is intended to be recalibrated, this may be done with an optimization method for generating the calibration data with the data, provided for this purpose, for generating the calibration data, for example in accordance with a mathematical model by way of bundle adjustment in accordance with Luhmann Robson, Kyle, Boehm, Close Range Photogrammetry and 3D Imaging, Second Edition, chapter 4, ISBN 978-3-1110-2986-3. The calibration parameters may be derived in a further optimization method by minimizing the deviations between the recorded recognizable features 8 of the reference object 7 and the recognizable features of the reference object 7 as correlated from the calibration data. This may be done for example in accordance with a mathematical model containing the calibration parameters of the robot kinematic system 1a, 1b, 1c, using methods for solving a nonlinear optimization problem according to Nocedal, Wright, Numerical Optimization, Second Edition, ISBN 978-1-4939-3711-0. However, both optimization methods may likewise be combined to form one optimization method. If necessary, the calibration parameters of the 3D digitizer 2 and/or of the camera 4 may also be adapted within a separate or combined optimization method if a scale-defining element is captured by the 3D digitizer 2 and/or the camera 4 (see Luhmann, Robson, Kyle, Boehm, Close Range Photogrammetry and 3D Imaging, Second Edition, ISBN 978-3-1110-2986-3) or, if necessary, the calibration parameters of the 3D digitizer 2 and/or of the camera 4 may also be adapted without a scale-defining element 6 being captured by the 3D digitizer 2 and/or the camera 4, if one of the robot links and thus a portion of the robot kinematic system 1a, 1b, 1c itself is the scale-defining element 6. Likewise, if necessary, scale-independent calibration parameters of the 3D digitizer 2 and/or of the camera 4 may also be adapted without a scale-defining element 6 being captured, if the scale-dependent parameters of the calibration of the 3D digitizer 2 and/or of the camera 4 have been captured beforehand with the aid of a scale-defining element 6.

The method according to an aspect of the disclosure may thus be used to calibrate the robot kinematic system 1a, 1b, 1c, if necessary to calibrate the reference object 7 and if necessary to calibrate the 3D digitizer 2 or the camera 4.

The minimization advantageously provides an ideal solution to the optimization problem.

An explanation will be given, by way of example, of an optimization problem to be solved for the case of calibrating two robot kinematic systems. In this case, let P_{LCS,i,j} contain the coordinates of the i-th recognizable feature 8 of the reference object 7 with respect to the j-th pose between the robot kinematic system 1a and 1b in the local reference coordinate system DCS of the 3D digitizer 2 or CCS of the camera 4, and Q_{LCS,i} contain the coordinates of the i-th recognizable feature 8 of the reference object 7 in the local reference coordinate system of the reference object 7. Let the forward kinematics of the first robot kinematic system 1a be described by the axis values J_{1,j} belonging to the j-th pose. Let the forward kinematics of the second robot kinematic system 1b be described by the axis values J_{2,j} belonging to the j-th pose. Axis values may be for example an angle or a displacement between structural components of the robot kinematic system 1a. The coordinates Q_{GCS,i,j} transformed into a global reference coordinate system, for example RCS1, as a function of the calibration parameters q for robot kinematic system 1a are given by applying a transformation function F_{1,q}, which may result for example from the successive execution of multiple transformations for the individual robot links of the robot kinematic system 1a. The coordinates P_{GCS,i,j} transformed into a global reference coordinate system RCS1 as a function of the calibration parameters p for robot kinematic system 1b are given by applying a transformation function F_{2,p}. This then also contains for example the transformation from RCS2 to RCS1.

Q_{GCS,i,j}(q)=F_{1,q}(Q_{LCS,i},J_{1,j}) (1)

P_{GCS,i,j}(p)=F_{2,p}(P_{LCS,i,j},J_{2,j}) (2)

There is thus an optimization problem (3)

$${min}_{p , q} {\sum }_{i , j} {( {P}_{GCS , i , j} ( p ) - {Q}_{GCS , i , j} ( q ) )}^{2} \qquad ( 3 )$$

to be solved. If the reference object is also intended to be calibrated, the optimization problem may be extended with the parameters r, wherein Q_{GCS,i,j}(q, r) are then the coordinates of the i-th recognizable feature of the recognizable features 8 of the reference object 7 with respect to the pose j, and these are likewise able to be adapted via the parameters r.

$${min}_{p , q , r} {\sum }_{i , j} {( {P}_{GCS , i , j} ( p ) - {Q}_{GCS , i , j} ( q , r ) )}^{2} \qquad ( 4 )$$

It is thereby possible to correct errors in the calibration of the recognizable features 8 of the reference object 7, which are recognized by deriving the calibration parameters. Had the recognizable features 8 of the reference object 7 been calibrated first and the calibration parameters of the robot kinematic systems 1a, 1b derived in a further optimization method, then the errors that were generated during the calibration would also have been present in the further optimization method for deriving the calibration parameters as follow-up errors. By way of example, the parameters r may contain the coordinates of the features 8 of the reference object 7.

The optimization methods and the identification of the calibration parameters may be formulated with the aid of the forward kinematics. However, it is just as possible to establish an equivalent optimization problem with the aid of inverse kinematics.

The calibration parameters of the robot kinematic system 1a, 1b, 1c may be for example geometric and/or elastic and/or thermal calibration parameters and/or calibration parameters of the robot kinematic system 1a, 1b, 1c that take into account the configuration of the robot kinematic system 1a, 1b, 1c, and/or calibration parameters that take into account the direction of approach, and/or calibration parameters of the characteristic of the or calibration parameters for determining the error curve of the length or angle measurement technology of the robot kinematic system 1a, 1b, 1c and/or calibration parameters that characterize the play of individual or all axes of the robot kinematic system 1a, 1b, 1c and/or calibration parameters that describe the dependence of the robot kinematic system 1a, 1b, 1c on other variables, which may for example be recorded using sensors or be calculated on the basis of the existing data.

In this case, the distance and angular position of the two coordinate systems RCS1 and RCS2 with respect to one another may likewise be considered to be a parameter of the robot kinematic system 1a, 1b, 1c.

Depending on the type of a robot kinematic system 1a, 1b, 1c and depending on the ambient conditions of the robot kinematic system 1a, 1b, 1c and depending on the type of 3D digitizer 2 or camera 4 and reference object 7, it is useful to use different combinations of calibration parameters for the optimization.

However, the method according to an aspect of the disclosure is not restricted to these calibration parameters, and may be supplemented and combined with other parameters.

The calibration parameters resulting from the optimization method may be used to determine the pose of the end effector of the respective robot kinematic system 1a, 1b, 1c and/or to align the end effector on the basis of the calibration parameters.

The adapted calibration parameters resulting from the optimization method may be used to place the end effector of the respective robot kinematic system 1a, 1b, 1c more accurately. This is expedient if the measurement of a measurement object 9 takes place after the robot kinematic system 1a, 1b, 1c has been calibrated. However, the calibration parameters may also be used to accurately determine a pose of the end effector. It is thus possible, for example, to use an inexpensive robot kinematic system 1a, 1b, 1c the approach accuracy of which into a certain pose is low for mechanical reasons, but the pose of which is nevertheless able to be determined accurately through the adapted calibration parameters. Furthermore, it is therefore also possible to subsequently correct the poses of a measurement. Accordingly, it is possible first to record data of the measurement object 9 with the 3D digitizer 2 in different poses of the 3D digitizer 2, and then to derive the calibration parameters of the robot kinematic system 1a, 1b, 1c on the basis of the method according to an aspect of the disclosure and to transfer the recorded data of the measurement object 9 into a global coordinate system, for example RCS1 or RCS2, on the basis of the subsequently derived calibration parameters.

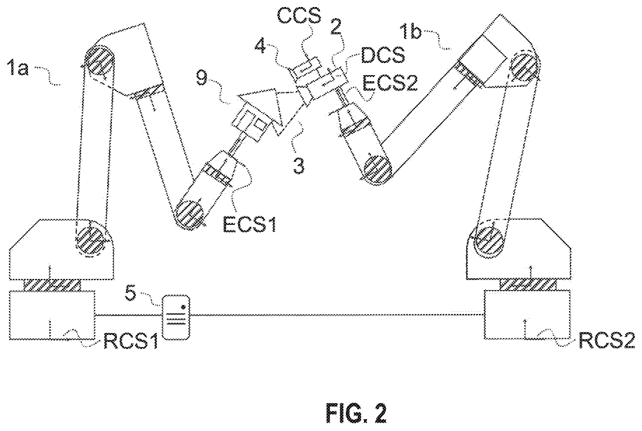

As shown in FIG. 2, it is thus possible to bring a measurement object 9 fastened to a robot kinematic system 1a and a 3D digitizer 2 fastened to a robot kinematic system 1b into different poses in order to measure the measurement object 9, and the 3D digitizer 2 can generate local 3D data in the reference coordinate system DCS of the 3D digitizer 2, and the local 3D data generated for the different poses may be transferred into a global coordinate system, for example RCS1 or RCS2, on the basis of the robot kinematic system 1a, 1b calibrated in accordance with the method according to the disclosure.

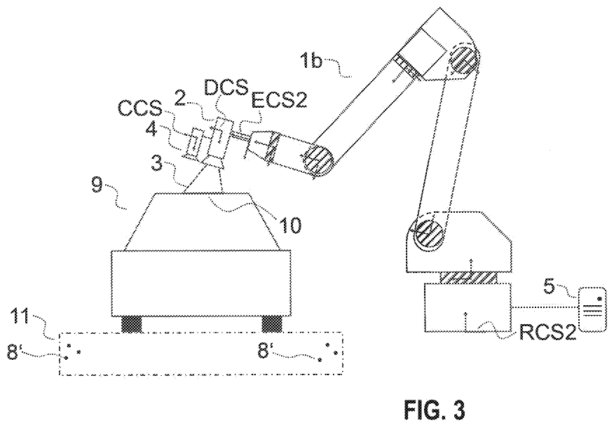

As shown in FIG. 3, it is however also possible to bring just a 3D digitizer 2 fastened to a robot kinematic system 1b into different poses in order to measure an initially stationary measurement object 9, and the 3D digitizer 2 can generate local 3D data in the reference coordinate system DCS of the 3D digitizer 2, and the local 3D data generated for the different poses may be transferred into a global coordinate system, for example RCS2, on the basis of the robot kinematic system 1a, 1b calibrated in accordance with the method according to an aspect of the disclosure.

Thus, during the measurement, the 3D data of a measurement object 9, in which a 3D digitizer 2 can capture only subregions 10 of the measurement object 9 with its measurement volume 3, can be determined more accurately as a whole through the precise transfer of the local 3D data into a global coordinate system RCS2.

Furthermore, a measurement object 9 may be aligned with respect to the robot kinematic system 1b on the basis of recognizable features 8′ that are distributed on or around the measurement object 9 and are captured by a 3D digitizer 2 and/or camera 4 fastened to a robot kinematic system 1b, wherein the robot kinematic system 1b has been calibrated in accordance with the method according to an aspect of the disclosure. This is expedient for example if the measurement object 9 cannot be captured completely on account of its size and the limited arm length of the robot kinematic system 1b. As shown in FIG. 3, the measurement object 9 may be located for example on a mobile platform 11 that has recognizable features 8′, wherein the recognizable features 8′ may differ from the recognizable features 8. A measurement sequence may for example take place as follows:
Providing a measurement object 9 attached to a mobile platform 11;
Generating first 3D data by carrying out a first measurement of the recognizable features 8′ with the 3D digitizer 2 in the local reference coordinate system DCS of the 3D digitizer 2 and transforming the first 3D data generated with the 3D digitizer 2 into a global reference coordinate system RCS2;
Generating second 3D data by carrying out a first measurement of the measurement object 9 with the 3D digitizer 2 fastened to the robot kinematic system 1b in different poses and, for each measurement in the corresponding pose, carrying out a transformation of the second 3D data measured in the local reference coordinate system DCS of the 3D digitizer 2 into the global reference coordinate system RCS2;
Displacing the measurement object 9 with the mobile platform 11 in order to be able to measure the hitherto unreachable regions of the measurement object 9;
Generating third 3D data by carrying out a second measurement of the recognizable features 8′ with the 3D digitizer 2 in the local reference coordinate system DCS of the 3D digitizer 2 and transforming the third 3D data generated with the 3D digitizer 2 into a global reference coordinate system RCS2;
Determining the displacement and the rotation of the mobile platform 11 in the global reference coordinate system RCS2 on the basis of the first and second 3D data of the recognizable features 8′ recorded in the first and second measurement; and
Generating fourth 3D data by carrying out a second measurement of the measurement object 9 with the 3D digitizer 2 fastened to the robot kinematic system 1b in different poses and, for each measurement in the corresponding pose, carrying out a transformation of the fourth 3D data measured in the local reference coordinate system DCS of the 3D digitizer 2 into the global reference coordinate system RCS2, and displacing and rotating the second 3D data to match the fourth 3D data on the basis of the determined displacement and rotation of the mobile platform 11.

As an alternative to displacing the measurement object 9 on the mobile platform 11, it is also possible to additionally displace the robot kinematic system 1b, or to displace only the robot kinematic system 1b.

An analogous process may also be applied to a robot kinematic system 1c, not illustrated in the figures, or to a robot kinematic system 1a if the reference object 7 is replaced by a 3D digitizer 2 and/or a camera 4.

However, a mobile platform 11, provided for example that position data of the mobile platform 11 can be read out via the controller of the mobile platform 11, may itself also be a robot kinematic system 1a, 1b, 1c, and the mobile platform 11 is calibrated in accordance with the method according to an aspect of the disclosure, such that the measured 3D data of the measurement object 9 are thereby transferred into a global reference coordinate system.

Generally speaking, the constructions shown in the exemplary applications are not restricted to one, two or three robot kinematic systems 1a, 1b, 1c. It is also possible to calibrate entire series of robot kinematic systems 1a, 1b, 1c and to transfer them into a common reference coordinate system.

However, this also means that a measurement object 9 may be measured with multiple 3D digitizers 2 on robot kinematic systems 1a, 1b, 1c, and the measurement data may be transferred into a common reference coordinate system RCS1 or RCS2 or RCS3, etc.

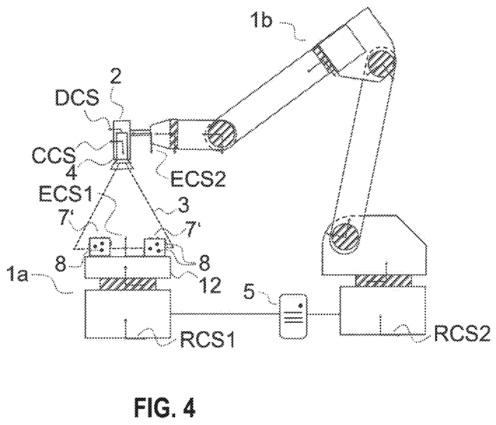

A further exemplary embodiment of an apparatus is illustrated in FIG. 4. This shows a rotary table as a first robot kinematic system 1a and a six-axis robot as a second robot kinematic system 1b. The robot kinematic systems 1a, 1b may be controlled separately or by a controller located for example on a computer 5. If one of the robot kinematic systems 1a, 1b is already calibrated sufficiently well, it may be sufficient to calibrate the other robot kinematic system 1b, 1a in accordance with the present method in order to determine the position and orientation between the end effectors ECS1 and ECS2 or the position and orientation between CCS or DCS and ECS1. However, it is also possible for both robot kinematic systems 1a, 1b to be simultaneously calibrated, and calibrated relative to one another, in accordance with the present method, such that all calibration parameters of the robot kinematic system 1a, 1b are determined at once and the position and orientation of the two end effectors ECS1, ECS2 relative to one another or the position and orientation of CCS, DCS with respect to ECS1 are determined therefrom. In order to carry out the method according to an aspect of the disclosure, the camera 4 is part of the 3D digitizer 2 in this example. In this case, in its dual function, it supplies 2D data, in particular for calibrating the reference object 7, which is represented here by two partial reference objects 7′ located on the rotary plate 12, on the one hand, and generates data for the 3D digitizer in order to calculate 3D data, which are used in particular to derive calibration parameters, on the other hand. The coordinate systems CCS and DCS may also be identical here.

It is pointed out here that the method according to an aspect of the disclosure may be applied not just to a 3D measurement. For instance, in addition to the 3D digitizer 2 and/or camera 4 and/or reference object 7, one or more further tools may be fastened to the robot kinematic systems 1a, 1b, 1c and/or the 3D digitizer 2 and/or camera 4 and/or reference object 7 on the robot kinematic systems 1a, 1b, 1c may be replaced by one or more tools, such that other tasks are also able to be carried out using the robot kinematic systems 1a, 1b, 1c.

It goes without saying that the exemplary embodiments shown here serve merely to schematically illustrate the principle and execution of the present disclosure. Various modifications of a functional and structural nature are possible without departing from the scope of the present disclosure.

### LIST OF REFERENCE NUMERALS

1a robot kinematic system
1b second robot kinematic system
2 3D digitizer
3 measurement volume
4 camera
5 computer
6 scale-defining object
7 reference object
8 recognizable features
9 measurement object
10 subregions
11 mobile platform
12 rotary plate
CCS local reference coordinate system
DCS local reference coordinate system
ECS1 coordinate system
ECS2 coordinate system
RCS1 global reference coordinate system
RCS2 global reference coordinate system

What is claimed is:

1. A method for calibrating at least one robot kinematic system, the method comprising:
fastening at least one reference object having recognizable features to a first robot kinematic system of the at least one robot kinematic system;
fastening at least one 3D digitizer and/or at least one camera to a second robot kinematic system of the at least one robot kinematic system or to a third robot kinematic system of the at least one robot kinematic system,
bringing the at least one reference object and the at least one 3D digitizer and/or the at least one camera into different relative poses with respect to one another by the first robot kinematic system and at least one of the second and third robot kinematic systems;
recording data of the recognizable features of the at least one reference object by the at least one 3D digitizer and/or the at least one camera in the different relative poses; and
deriving first calibration parameters for at least one of the at least one robot kinematic system at least from a portion of the recorded data by minimizing deviations between first coordinates and second coordinates of the recognizable features of the reference object,
wherein the first coordinates are derived from the recorded data, and
wherein the second coordinates are calculated from a mathematical model.

2. The method as claimed in claim 1, further comprising at least one of:
calibrating the reference object before deriving the first calibration parameters or during deriving the first calibration parameters and thereby correlating the recognizable features of the reference object in a coordinate system; and
adapting second calibration parameters of the at least one 3D digitizer or of the at least one camera.

3. The method as claimed in claim 1, wherein the at least one 3D digitizer is a triangulation sensor.

4. The method as claimed in claim 1, further comprising at least one of:
providing a scale-defining element on the at least one reference object, and
defining a robot link as the scale-defining element.

5. The method as claimed in claim 1, wherein the recognizable features of the reference object are correlated in absolute terms by at least one absolute measurement with the at least one 3D digitizer, and
wherein the at least one 3D digitizer is a scale-defining element.

6. The method as claimed in claim 1, further comprising:
transferring at least a portion of data of the recognizable features of the at least one reference object that are present in a local reference coordinate system of the at least one 3D digitizer and/or that are present in a local reference coordinate system of the at least one camera into a global reference coordinate system.

7. The method as claimed in claim 1, wherein the first calibration parameters of the robot kinematic system are at least one of:
geometric calibration parameters,
elastic calibration parameters,
thermal calibration parameters,
calibration parameters of the at least one robot kinematic system which take into account a configuration of the at least one robot kinematic system,
calibration parameters which take into account a direction of approach,
calibration parameters of a characteristic of error curves or calibration parameters for determining the error curves of a length or angle measurement technology of the at least one robot kinematic system,
calibration parameters which characterize a play of individual or all axes of the at least one robot kinematic system, and
calibration parameters which describe a dependence of the at least one robot kinematic system on other variables, which may be recorded with sensors or which may be calculated based on existing data.

8. The method as claimed in claim 7, further comprising at least one of:
determining the pose of at least one end effector of the at least one robot kinematic system based on the first calibration parameters, and
aligning the at least one end effector of the at least one robot kinematic system based on the first calibration parameters.

9. A method for calibrating a plurality of robot kinematic systems, the method comprising:
fastening, in each case, at least one of: (a) the at least one 3D digitizer, (b) the at least one camera, and (c) the at least one reference object to the plurality of robot kinematic systems;
bringing the at least one reference object and the at least one 3D digitizer and/or the at least one camera into different relative poses with respect to one another by the plurality of robot kinematic systems;
recording data of the recognizable features of the at least one reference object by the at least one 3D digitizer and/or the at least one camera in the different relative poses; and
deriving first calibration parameters for at least one of the plurality of robot kinematic systems at least from a portion of the recorded data by minimizing deviations between first coordinates and second coordinates of the recognizable features of the reference object,
wherein the first coordinates are derived from the recorded data and the second coordinates are calculated from a mathematical model.

10. The method as claimed in claim 9, wherein the plurality of robot kinematic systems are calibrated relative to one another.

11. The method as claimed in claim 1, wherein at least one of the robot kinematic systems is a rotary table.

12. The method as claimed in claim 1, further comprising at least one of:
fastening, in addition to the at least one 3D digitizer and/or the at least one camera and/or the at least one reference object, one or more further tools to at least one of the at least one robot kinematic system, and
replacing the at least one 3D digitizer and/or the at least one camera and/or the at least one reference object by the one or more further tools on at least one robot kinematic system.

13. The method as claimed in claim 1, wherein the at least one reference object is configured such that the recognizable features are located on at least one of:
a separate body,
one or more arbitrary links of the at least one robot kinematic system,
the at least one 3D digitizer,
the at least one camera,
a tool,
a measurement object, and
around the measurement object.

14. The method as claimed in claim 1, wherein the recognizable features are at least one of:
optical markers which actively light up,
optical markers which are passively illuminated,
features recognizable in two dimensions having a unique 2D geometry, and
features recognizable in three dimensions having a unique 3D geometry.

15. A method for determining the 3D data of a measurement object, the method comprising:
fastening at least one 3D digitizer to a robot kinematic system or fastening a plurality of 3D digitizers to a plurality of robot kinematic systems;
brining the at least one 3D digitizer or the plurality of 3D digitizers into different poses for measuring a measurement object; and
generating, by the at least one 3D digitizer or by the plurality of 3D digitizers local 3D data in the reference coordinate systems of the at least one 3D digitizer or of the plurality of 3D digitizers,
wherein the local 3D data are generated for the different poses and are transferred into a global coordinate system based on the first calibration parameters of at least one robot kinematic system derived as claimed in claim 1.

16. A method for a relative alignment of a measurement object in relation to the at least one robot kinematic system based on recognizable features, the method comprising:
distributing the recognizable features on or around the measurement object;
capturing the recognizable features, by the at least one 3D digitizer fastened to the at least one robot kinematic system and/or by the at least one camera fastened to the at least one robot kinematic system; and
deriving the first calibration parameters of the at least one robot kinematic system as claimed in claim 1.

17. An apparatus for calibrating the at least one robot kinematic system, the apparatus comprising:
the at least one reference object having the recognizable features which is fastened to the first robot kinematic system of the at least one robot kinematic system; and
the at least one 3D digitizer fastened to the second robot kinematic system or to the third robot kinematic system, and/or the at least one camera fastened to the second robot kinematic system (1b) or to the third robot kinematic system,
wherein, for at least one of the at least one robot kinematic system, the first calibration parameters are derived as claimed in claim 1.

18. The apparatus as claimed in claim 17, further comprising at least one scale-defining element.

19. A robot kinematic system of the at least one kinematic system, the first calibration parameters of which have been derived as claimed in claim 1.

20. A non-transitory computer-readable storage medium on which a computer program is stored, wherein the computer program includes instructions which, when the computer program is executed by at least one processor, cause the at least one processor and/or further processors to carry out the method as claimed in claim 1.

21. A method for calibrating at least one robot kinematic system, at least one reference object having recognizable features being fastened to a first robot kinematic system of the at least one robot kinematic system, at least one 3D digitizer and/or at least one camera being fastened to a second robot kinematic system of the at least one robot kinematic system or to a third robot kinematic system of the at least one robot kinematic system, the method comprising:
bringing the at least one reference object and the at least one 3D digitizer and/or the at least one camera into different relative poses with respect to one another by the first robot kinematic system and at least one of the second and third robot kinematic systems;
recording data of the recognizable features of the at least one reference object by the at least one 3D digitizer and/or the at least one camera in the different relative poses; and
deriving first calibration parameters for at least one of the at least one robot kinematic system at least from a portion of the recorded data by minimizing deviations between first coordinates and second coordinates of the recognizable features of the reference object,
wherein the first coordinates are derived from the recorded data, and
wherein the second coordinates are calculated from a mathematical model.
